(19) United States
(12) Patent Application Publication
(10) Pub. No.: US 2014/0066925 A1
(43) Pub. Date: Mar. 6, 2014

(54) Vibrating Erogenic Stimulator Glove

(71) Applicant: Rheynard HOWARD, Houston, TX (US)

(72) Inventor: Rheynard HOWARD, Houston, TX (US)

(21) Appl. No.: 14/018,070

(22) Filed: Sep. 4, 2013

Related U.S. Application Data
(60) Provisional application No. 61/697,064, filed on Sep. 5, 2012.

(51) Int. Cl. A61H 23/00; A61H 19/00

(52) U.S. Cl. CPC A61H 23/00; A61H 19/30
USPC 606/38; 601/46

(57) ABSTRACT

A vibrating erogenic stimulator glove has an elastic textured surface with a geometric pattern of raised bumps, ridges or other protrusions. A vibration system is embedded within the elastic glove, and an electrical switch controls the electrical connection between a battery and the vibration motors.

The current application claims a priority to the U.S. Provisional Patent application Ser. No. 61/697,064 filed on Sep. 5, 2012.

### FIELD OF THE INVENTION

The present invention relates generally to gloves. More specifically the present invention is a glove that is designed to be used as an implement during sexual activities.

### BACKGROUND OF THE INVENTION

In the past many apparatuses and devices have been developed to be used in conjunction with sexual activities. These sexual activities may be carried out by a sole participant or by two as is traditional or potentially even more that two. It is the purpose of sex apparatuses to aid in the achievement of erogenic pleasure. Sex apparatuses in existence include devices such as phallic substitutes, vaginal substitutes, and vibrating stimulators. Such devices may be used either in conjunction with a sex act between two or more participants as an enhancement to the sexual activities or as a substitute for sexual contact between the participants. Sexual apparatuses are widely regarded as effective at aiding females in achieving erogenic pleasure and or orgasm. Additionally sex apparatuses carry no risk of the user being afflicted by sexually transmitted diseases (STDs) as long as the sex apparatus is not used by more than one person. One of the most popular forms of erogenic stimulation used by females is manual manipulation of the genitals. There are some sex apparatuses on the market that are meant to improve the act of manually stimulating the genitals. These apparatuses include finger attachments and hand worn gloves which contain vibrating components to more effectively stimulated the erogenous zones. These devices suffer from being to bulky and as a result are not as effective as sex apparatuses as they could be. It is therefore an object of the present invention to create a sex apparatus which is designed to be worn on the hand of a user like a glove. It is a further object of the present invention to provide vibratory components to aid in stimulation of the erogenous zones without making the apparatus to large and bulky.

### BRIEF DESCRIPTION OF THE DRAWINGS

FIG. 1 is a front view of the present invention with the textured surface having the geometrical pattern of raised bumps.

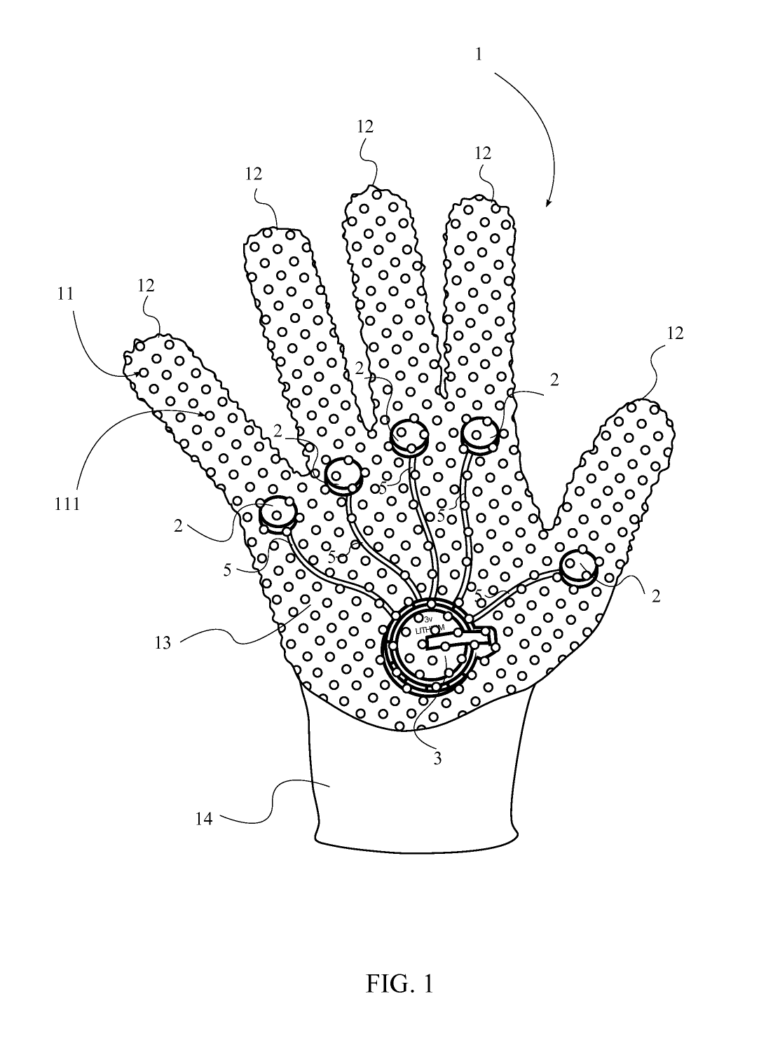

FIG. 2 is a front view of the present invention with the textured surface having the geometrical pattern of raised ridges.

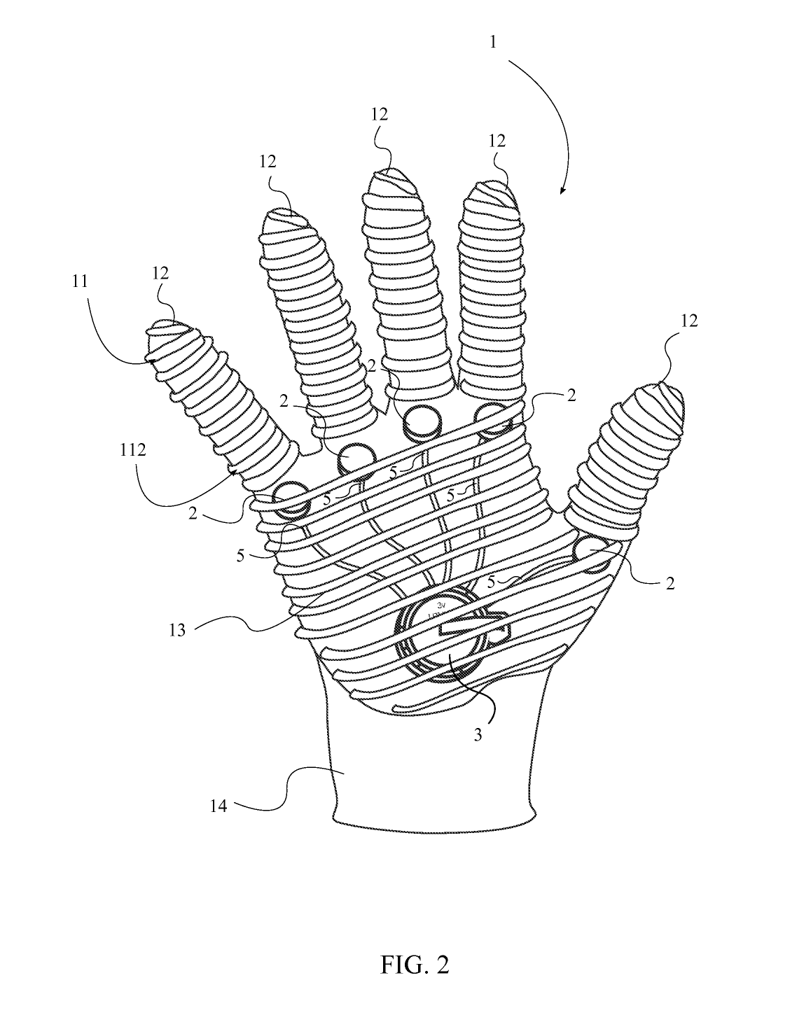

FIG. 3 is a front view of the present invention with the textured surface having the combination geometrical pattern of raised bumps.

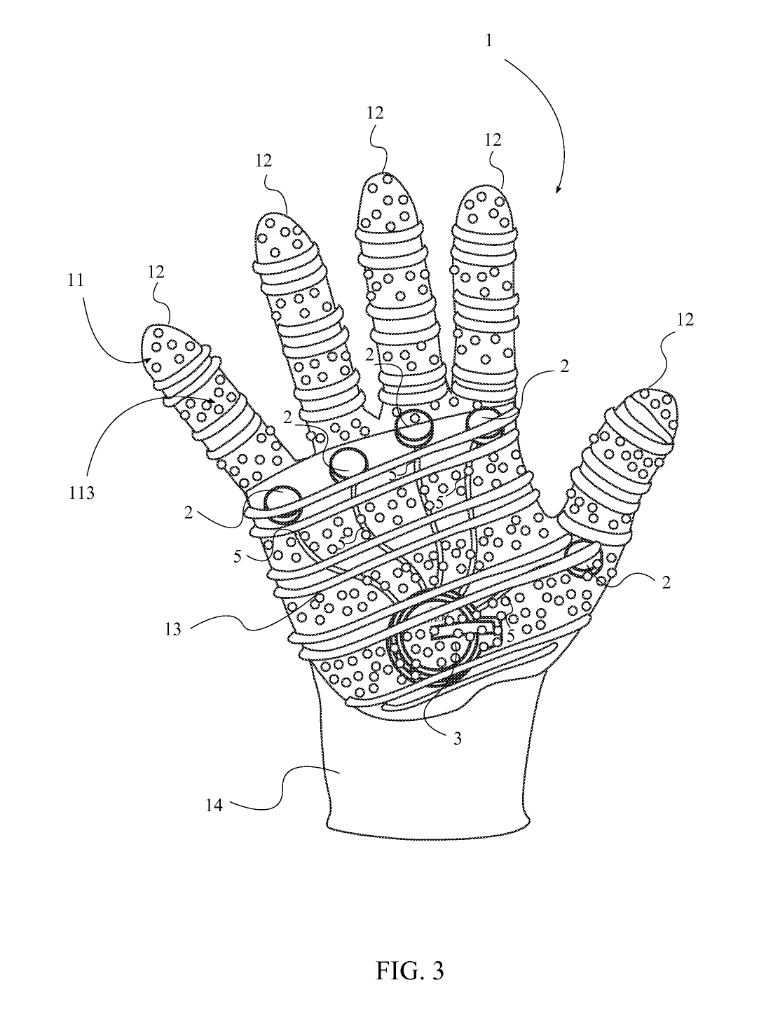

FIG. 4 is a front view of an alternate embodiment of the present invention with the textured surface having the geometrical pattern of raised bumps.

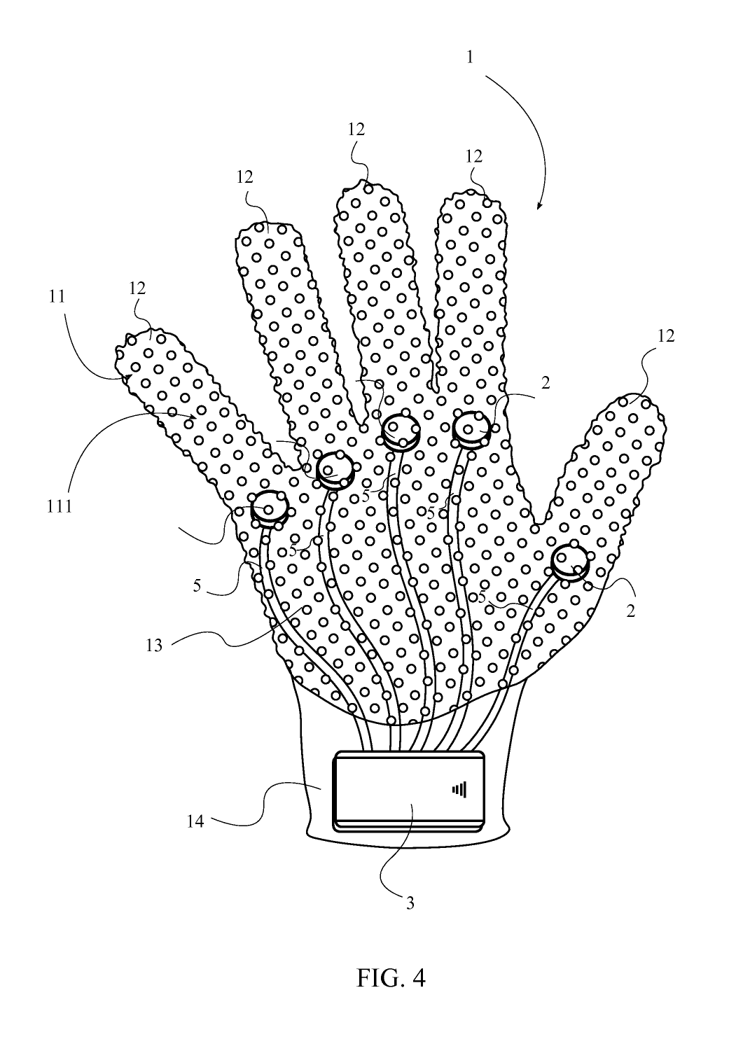

FIG. 5 is a front view of an alternate embodiment of the present invention with the textured surface having the geometrical pattern of raised ridges.

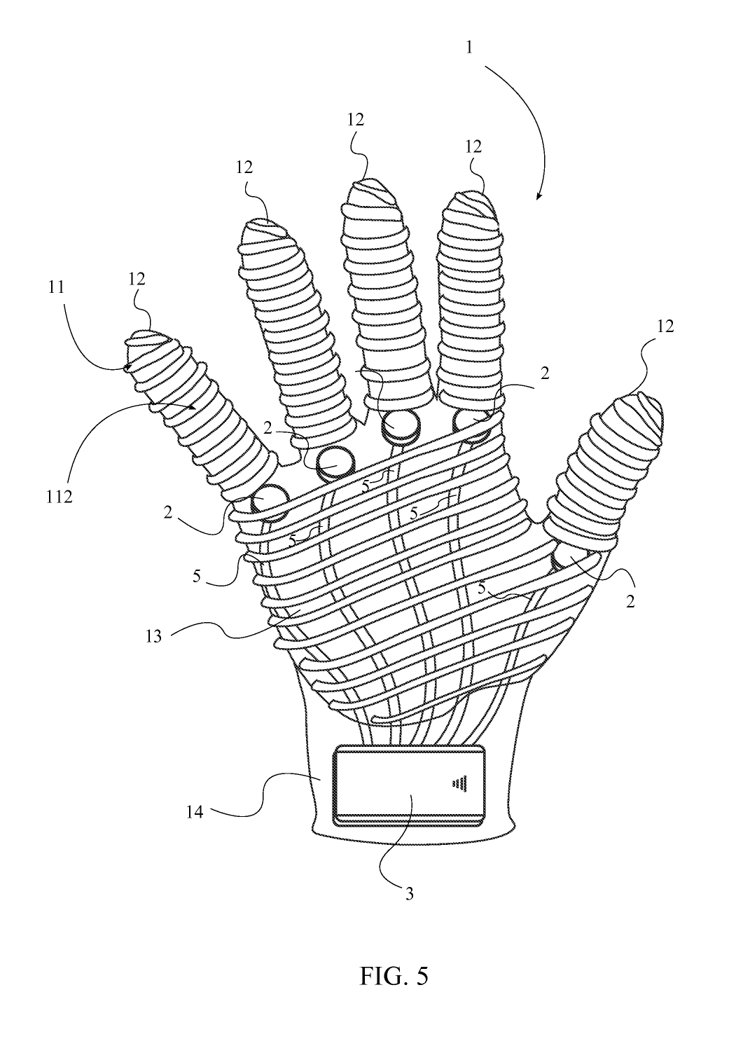

FIG. 6 is a front view of an alternate embodiment of the present invention with the textured surface having the combination geometrical pattern of raised bumps.

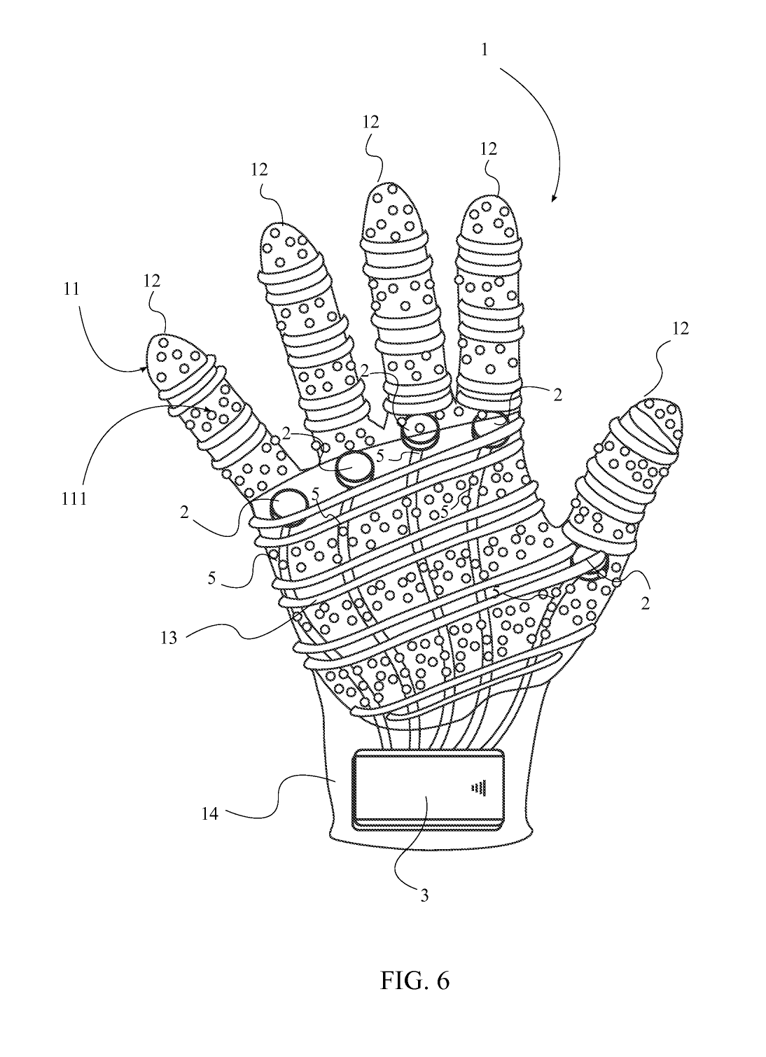

FIG. 7 is a front view of an alternate embodiment of the present invention with the geometrical pattern of raised bumps and the outer glove layer separated from the inner glove layer.

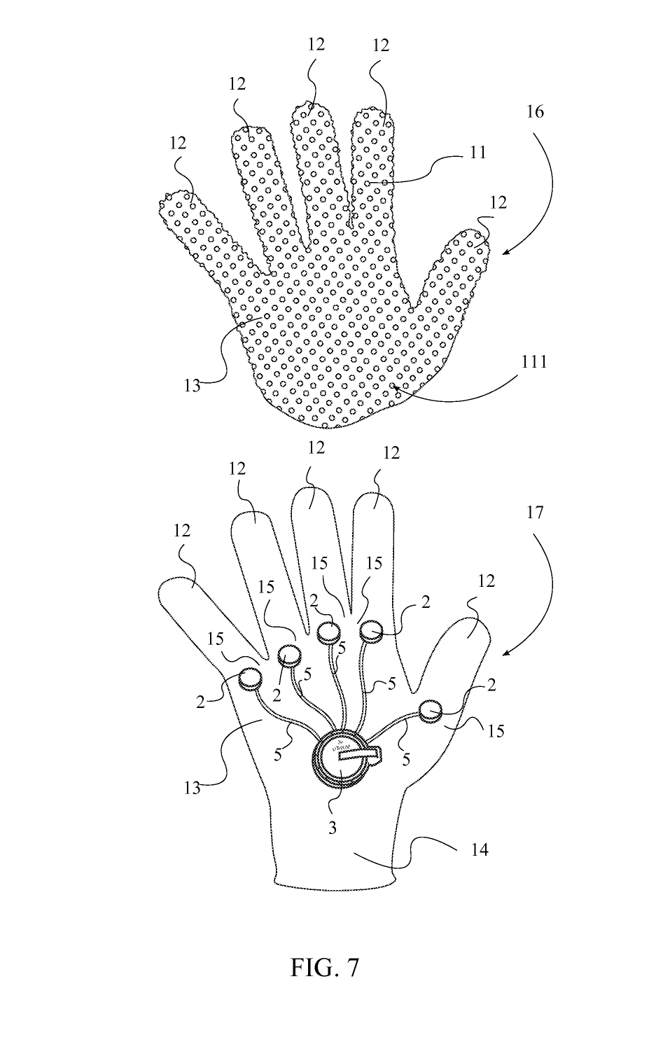

FIG. 8 is a front view of an alternate embodiment of the present invention with the geometrical pattern of raised ridges and the outer glove layer separated from the inner glove layer.

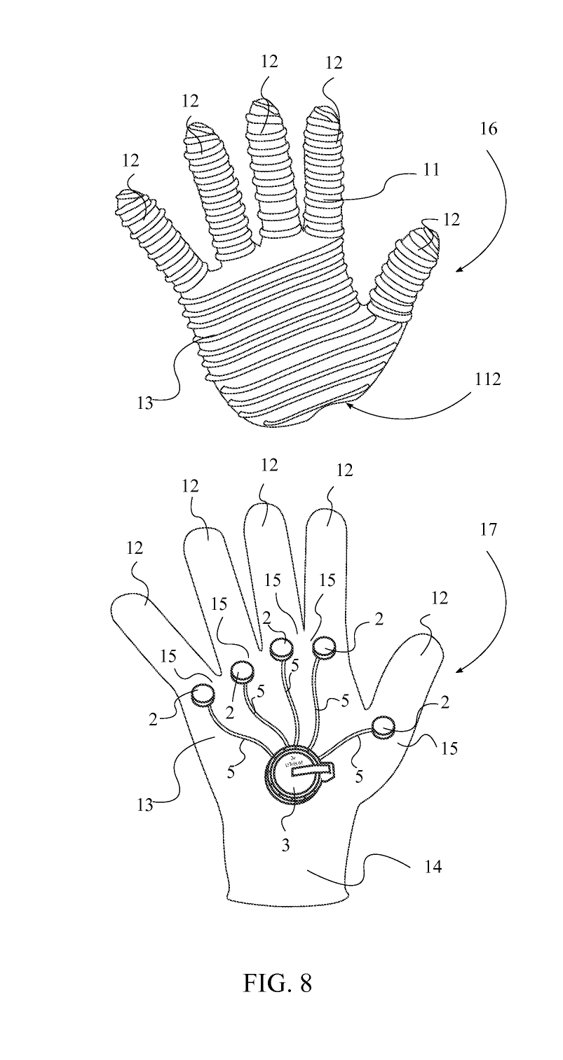

FIG. 9 is a front view of an alternate embodiment of the present invention with the combination geometrical pattern of raised ridges and raised bumps and the outer glove layer separated from the inner glove layer.

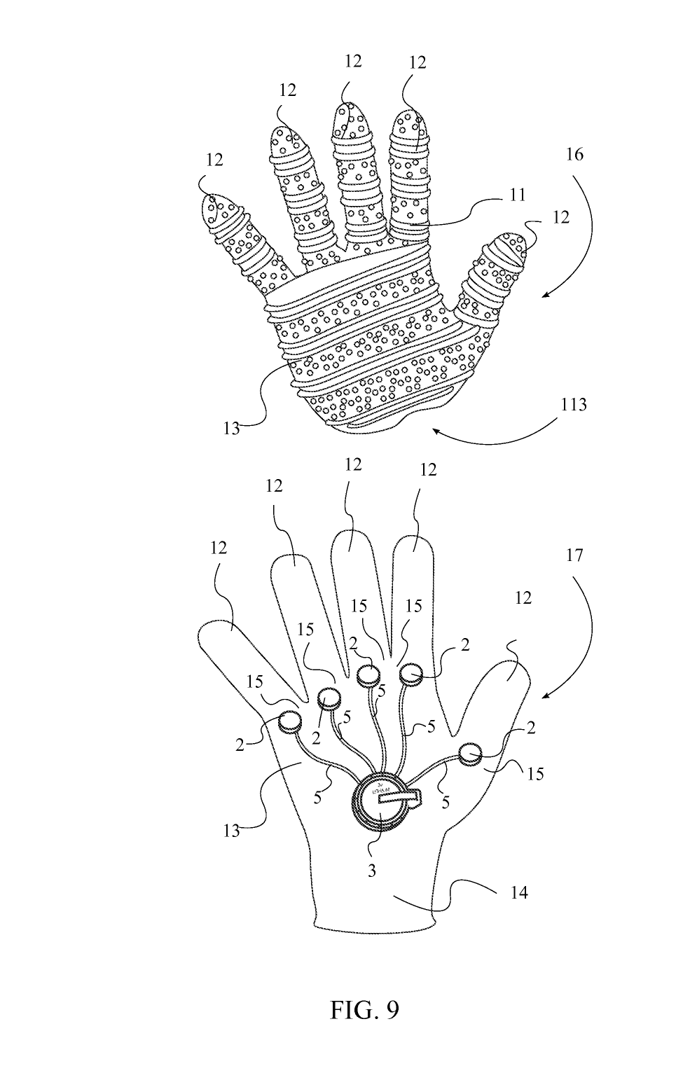

FIG. 10 is an electrical schematic showing electrical connections between components according to the preferred embodiment of the present invention.

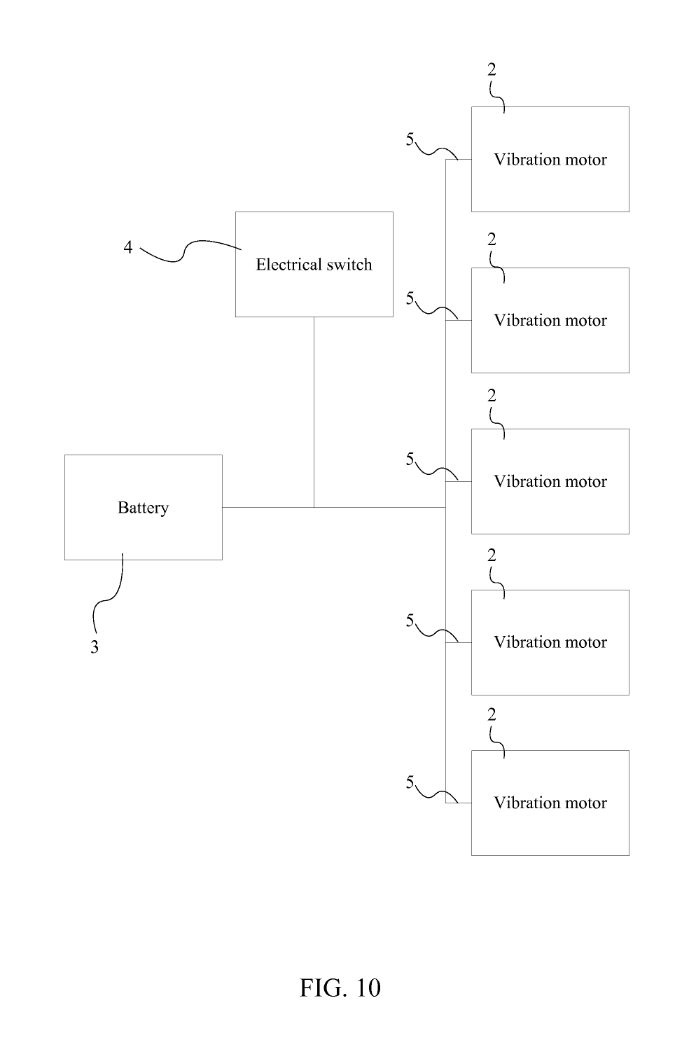

### DETAIL DESCRIPTIONS OF THE INVENTION

All illustrations of the drawings are for the purpose of describing selected versions of the present invention and are not intended to limit the scope of the present invention.

The present invention is a glove shaped to fit comfortably over a human hand which has a textured surface 11 and a vibration system for use in sexual activities. The glove is manufactured out of an elastic material such that the present invention conforms tightly to the wearer's hand. It is important to note that the present invention covers the entirety of the user's hand up to their wrist. The complete coverage of the present invention offers the user with the ability to use the entire surface of their hand as a sex apparatus to enhance their sexual pleasure. Additionally, the complete coverage means that a secondary user could wear the glove and stimulate the primary user without coming into direct contact with the primary user's genitals. Thus, the chance of a sexually transmitted infection (STI) being transferred while using the present invention is drastically reduced. This promotes safe sex practices as sexual partners have a way to engage in sexual activates while minimizing the chance of an STI being transferred which overall is good for the general population.

The present invention generally comprises an elastic glove 1, a plurality of vibration motors 2, a battery 3, an electrical switch 4, and a plurality of wires 5. In the preferred embodiment, the plurality of vibration motors 2, the battery 3, the switch, and the plurality of wires 5 are positioned within the material of the elastic glove 1.

The elastic glove 1 is preferably manufactured out of an elastic material such that the present invention conforms tightly to a user's hand and is flexible to accommodate unrestricted motion of the use's hand. It is important to note that the elastic glove 1 covers the entirety of the user's hand up to the user's wrist. The elastic glove 1 comprises a textured surface 11, a plurality of finger portions 12, a palm portion 13, and a wrist portion 14. The wrist portion 14 is connected adjacent to the palm portion 13, each of the plurality of finger portions 12 is connected adjacent to the palm portion 13 opposite the wrist portion 14, and each of the finger portions are positioned serially adjacent to each other, as is well known for gloves.

The textured surface 11 is for stimulating erogenous zones during sexual activity through physical contact. The textured surface 11 has a geometrically patterned plurality of protrusions distributed across the textured surface 11. The protrusions are well known in the art to enhance the erogenic capabilities of sex apparatuses, providing a very pleasing sensation for the primary user. The textured surface 11 may comprise a number of different configurations. Configurations for the preferred embodiment of the present invention are as follows.

In one embodiment of the present invention, the textured surface 11 comprises a geometrical pattern of raised bumps 111 which is evenly distributed across the textured surface 11. In another embodiment, the textured surface 11 comprises a geometrical pattern of raised ridges 112 which is evenly distributed across the textured surface 11. In another embodiment, the textured surface 11 comprises a combination geometrical pattern of raised ridges and raised bumps 113 that is evenly distributed across the textured surface 11. Additional embodiments of the textured surface 11 which are not specifically described herein also may be comprised in alternative embodiments of the present invention.

The present invention comprises a vibration system for enhancing the erogenic properties of the present invention through delivering vibrations to a user's erogenous zones for additional enjoyment. The vibration system includes all electrical components of the present invention, including the plurality of vibration motors 2, the battery 3, the electrical switch 4, and the plurality of wires 5. The plurality of vibration motors 2 preferably comprises five identical vibration motors.

The elastic glove 1 further comprises a plurality of joint locations 15. Each of the plurality of joint locations 15 is located at an intersection between one of the finger portions and the palm portion 13. In the preferred embodiment of the present invention, each of the plurality of vibration motors 2 is positioned at one of the plurality of joint locations 15 so that the plurality of vibration motors 2 is arranged across the user's palm. In alternative embodiments of the present invention, fewer vibration motors may be comprised to reduce manufacturing costs, so that the present invention is less costly but still capable of providing the user with stimulation from vibrations. The plurality of vibration motors 2, the battery 3, the electrical switch 4, and the plurality of wires 5 are all embedded within the material of the elastic glove 1. Thus, the electronic components are not exposed and are not susceptible to damage that may occur from contact with lubricant or bodily fluids.

Each of the plurality of vibration motors 2 is electrically connected to the battery 3 by the plurality of wires 5. The electrical switch 4 is electrically connected to the battery 3, providing a means for controlling the electrical connection between the battery 3 and the plurality of vibration motors 2. The electrical switch 4 may be embodied in a variety of different ways, such as, but not limited to, a push button, a slider switch, a toggle switch, or a rotary switch. In an alternative embodiment of the present invention, the electrical switch 4 is positioned on or adjacent to the wrist portion 14, or in a more convenient location.

In one alternate embodiment of the present invention, all the components of the vibration system embedded into the material of the elastic glove 1. This means that the user cannot access any of the electrical components and therefore cannot replace the battery 3 or any of the other components of the vibration system. However, in the preferred embodiment the battery is accessible for removal and replacement, or is rechargeable, or both. In another embodiment of the present invention, the present invention is either disposable and meant to be used for a very limited number of times, or the vibration system, including the electrical switch 4, is completely embedded in the material of the glove portion and as such the present invention can be washed without taking any damage. When the battery 3 is expended, the user must purchase a new unit if they wish to continue to enjoy the functionality offered by the vibration system of the present invention.

In one embodiment of the present invention, the battery 3 is positioned within the palm portion 13, wherein the batter is embedded within the material of the elastic glove 1. In an alternate embodiment, the battery 3 is positioned on the wrist portion 14, wherein the battery 3 is not embedded in the material of the elastic glove 1 and as such may be easily accessed by the user. This embodiment of the present invention allows the user to quickly and easily change the batteries of the present invention so as to continue to enjoy the erogenic effects offered by the vibration system. In another alternate embodiment, the elastic glove 1 has a cleft that allows access to the battery 3 so that the user may replace the battery 3 when the battery 3 is expended. In general, in the preferred embodiment of the present invention, the battery is accessible for removal and replacement or for being recharged by being plugged into a wall outlet or another source of electricity.

In an alternative preferred embodiment of the present invention, the elastic glove 1 comprises an outer glove layer 16, an inner glove layer 17, a plurality of finger portions 12, and a palm portion 13. This embodiment presents another solution to allow the user to both change the battery 3 and still maintain full protection of the electrical components of the vibration system from contact with lubricants and bodily fluids. In the preferred embodiment of the present invention, the inner glove layer is removably positioned within the outer glove layer 16, and the inner glove layer 17 is smooth and manufactured of an elastic material such that the inner glove layer 17 fits snugly over a wide range of user hand sizes. The plurality of vibration generators, the battery 3, the electrical switch 4, and the plurality of wires 5 are attached to the inner glove layer 17. The outer glove layer 16 is preferably slightly thicker than the inner glove layer 17, and comprises the textured surface 11 as previously described.

The outer glove layer 16 fits over the inner glove layer 17 and as such protects the vibration system from coming in contact with lubricant or bodily fluids. The ability to separate the inner glove layer 17 and the outer glove layer 16 in this embodiment allows for two advantages. First, the outer glove layer 16 can be removed and washed after being used. This promotes sanitation and safe sex practices and as such further reduces the chance of STI proliferation that may occur as a result of engaging in sexual activities using the present invention. The second advantage offered by this embodiment is the fact that the vibration system is completely accessible by the user when the outer glove layer 16 is removed from the inner glove layer 17. This allows for the user to both replace the battery 3 to allow for continued operation of the vibration system and to make repairs to the vibration system if the user is technically skilled. This can save the user money as they will not need to buy a unit unless the one they are using suffers from a breakdown that cannot be repaired.

The inner glove layer 17 comprises the wrist portion 14. In this embodiment, the inner glove layer 17 is removably positioned within the outer glove layer 16, and the plurality of vibration motors 2, the battery 3, the switch, and the plurality of wires 5 are positioned between the outer glove layer 16 and the inner glove layer 17. In the alternative preferred embodiment, the wrist portion is connected adjacent to the palm portion 13 of the inner glove layer 17. The battery 3 may be positioned within the wrist portion 14, or the battery 3 may be positioned between the palm portion 13 of the inner glove and the palm portion 13 of the outer glove layer 16.

It is contemplated that alternative embodiments of the present invention exist which utilize alternative components to provide additional stimulation to the primary user as opposed to the vibration system as described in the preferred embodiment. It is contemplated that this alternative embodiment may use a plurality of magnets that are embedded in the material of the elastic glove 1 instead of the vibration system. the plurality of magnets is embedded in the material of the elastic glove 1 similar to how the plurality of vibration generators is embedded into the material of the elastic glove 1 in the preferred embodiment. It is contemplated that the plurality of magnets may induce a pleasurable sensation for the primary user when the present invention is brought in close contact with the primary user's genitals. This hypothesis is based on the fact that magnetic fields are known to influence the iron in human blood and it is well known that the genitals have a very high saturation of both blood and nerve endings. The nerve endings could potentially be affected by the magnetic field through the principles of magnetic induction which define that electrical current can be generated in a conductor moving through a magnetic field. For this reason, this embodiment of the present invention contemplates the possible use of magnets for erogenic stimulation in the present invention.

Although the invention has been explained in relation to its preferred embodiment, it is to be understood that many other possible modifications and variations can be made without departing from the spirit and scope of the invention as hereinafter claimed.

What is claimed is:

1. A vibrating erogenic stimulator glove comprises:
an elastic glove comprising a textured surface, a plurality of finger portions, a palm portion, and a wrist portion;
a plurality of vibration motors;
a battery;
an electrical switch;
a plurality of wires; and
the plurality of vibration motors, the battery, the switch, and the plurality of wires being positioned within the elastic glove.
the wrist portion being connected adjacent to the palm portion;
each of the plurality of finger portions being connected adjacent to the palm portion opposite the wrist portion; and
each of the plurality of finger portions being positioned serially adjacent to each other.

2. The vibrating erogenic stimulator glove as claimed in claim 1 comprises:
the elastic glove further comprises a plurality of joint locations;
each of the plurality of joint locations being located at an intersection between one of the finger portions and the palm portion; and
each of the plurality of vibration motors being positioned at one of the plurality of joint locations.

3. The vibrating erogenic stimulator glove as claimed in claim 1, wherein the battery is removably positioned within the palm portion.

4. The vibrating erogenic stimulator glove as claimed in claim 1, wherein the battery is removably positioned within the wrist portion.

5. The vibrating erogenic stimulator glove as claimed in claim 1, wherein the battery is removably positioned within the wrist portion.

6. The vibrating erogenic stimulator glove as claimed in claim 1, wherein the battery is rechargeable.

7. The vibrating erogenic stimulator glove as claimed in claim 1 comprises:
each of the plurality of vibration motors being electrically connected to the battery by the plurality of wires; and
the electrical switch being electrically connected to the battery, wherein the electrical switch controls the electrical connection between the battery and the plurality of vibration motors.

8. The vibrating erogenic stimulator glove as claimed in claim 1 comprises:
the textured surface comprises a geometrical pattern of raised bumps; and
the geometrical pattern of raised bumps being evenly distributed across the textured surface.

9. The vibrating erogenic stimulator glove as claimed in claim 1 comprises:
the textured surface comprises a geometrical pattern of raised ridges; and
the geometrical pattern of raised ridges being evenly distributed across the textured surface.

10. The vibrating erogenic stimulator glove as claimed in claim 1 comprises:
the textured surface comprises a combination geometrical pattern of raised ridges and raised bumps; and
the combination geometrical pattern of raised ridges and raised bumps being evenly distributed across the textured surface.

11. A vibrating erogenic stimulator glove comprises:
an elastic glove comprising an outer glove layer, an inner glove layer, a plurality of finger portions, and a palm portion;
the outer glove layer comprises a textured surface;
the inner glove layer comprises a wrist portion;
a plurality of vibration motors;
a battery;
an electrical switch;
a plurality of wires;
the inner glove layer being removably positioned within the outer glove layer; and
the plurality of vibration motors, the battery, the switch, and the plurality of wires being positioned between the outer glove layer and the inner glove layer. the wrist portion being connected adjacent to the palm portion of the inner glove layer;
each of the plurality of finger portions being connected adjacent to the palm portion opposite the wrist portion; and
each of the plurality of finger portions being positioned serially adjacent to each other.

12. The vibrating erogenic stimulator glove as claimed in claim 11 comprises:
the elastic glove further comprises a plurality of joint locations;
each of the plurality of joint locations being located at an intersection between one of the finger portions and the palm portion; and
each of the plurality of vibration motors being positioned at one of the plurality of joint locations.

13. The vibrating erogenic stimulator glove as claimed in claim 11, wherein the battery is positioned between the palm portion of the inner glove layer and the palm portion of the outer glove layer.

14. The vibrating erogenic stimulator glove as claimed in claim 11, wherein the battery is removably positioned within the wrist portion.

15. The vibrating erogenic stimulator glove as claimed in claim 11, wherein the battery is replaceable.

16. The vibrating erogenic stimulator glove as claimed in claim 11, wherein the battery is rechargeable.

17. The vibrating erogenic stimulator glove as claimed in claim 11 comprises:
each of the plurality of vibration motors being electrically connected to the battery by the plurality of wires; and
the electrical switch being electrically connected to the battery, wherein the electrical switch controls the electrical connection between the battery and the plurality of vibration motors.

18. The vibrating erogenic stimulator glove as claimed in claim 11 comprises:
the textured surface comprises a geometrical pattern of raised bumps; and
the geometrical pattern of raised bumps being evenly distributed across the outer textured surface.

19. The vibrating erogenic stimulator glove as claimed in claim 11 comprises:
the textured surface comprises a geometrical pattern of raised ridges; and
the geometrical pattern of raised ridges being evenly distributed across the outer textured surface.

20. The vibrating erogenic stimulator glove as claimed in claim 11 comprises:
the textured surface comprises a combination geometrical pattern of raised ridges and raised bumps; and
the combination geometrical pattern of raised ridges and raised bumps being evenly distributed across the outer textured surface.
